(19) United States
(12) Patent Application Publication
(10) Pub. No.: US 2016/0070859 A1
(43) Pub. Date: Mar. 10, 2016

(54) FAST AND SECURE RETRIEVAL OF DNA SEQUENCES

(71) Applicant: KONINKLIJKE PHILIPS N.V., Eindhoven (NL)

(72) Inventor: Tanya IGNATENKO, Eindhoven (NL)

(21) Appl. No.: 14/786,207

(22) PCT Filed: Apr. 30, 2014
(86) PCT No.: PCT/IB2014/061098

§ 371 Date: Oct. 22, 2015

Related U.S. Application Data
(60) Provisional application No. 61/826,619, filed on May 23, 2013.

(51) Int. Cl. G06F 19/28; G06F 17/30

(52) U.S. Cl. CPC G06F 19/28; G06F 17/30327; G06F 17/30501

(57) ABSTRACT

Sequence models are retrieved from a sequences index. The sequence models model DNA or RNA sequences stored in a database, and each comprises a finite memory tree source model and parameters for the finite memory tree source model. One or more DNA or RNA sequences stored in the database are identified as being most similar to a query DNA or RNA sequence based on fitting of the retrieved sequence models to the query DNA or RNA sequence. The sequence models may be context tree weighting (CTW) models {Sₓ, θ_{Sx}} where Sₓ denotes the context tree model for the DNA or RNA sequence x stored in the database, and θ_{Sx} denotes parameters of the context tree model Sₓ. The fitting may include, for each CTW model {Sₓ, θ_{Sx}}, computing the codeword length for the query DNA or RNA sequence y using the CTW model {Sₓ, θ_{Sx}.

The following relates to genomic sequence indexing, storage, retrieval, processing, labeling, and related tasks, as well as to aspects such as patient privacy and medical data security and to applications such as medical diagnosis, medical screening, and so forth. While described with illustrative reference to deoxyribonucleic acid (DNA) sequences, the following finds application in conjunction with genomic sequences such as DNA sequences, ribonucleic acid (RNA) sequences, and so forth.

DNA sequencing has numerous existing and contemplated commercial, medical, and scientific applications, such as diagnosis of cancer and other illnesses, medical screening for genetic disorders, personalized medical treatments, personalized drug design, genetic anthropology and evolutionary studies, genealogical studies, forensic human identification, and so forth. In medical fields, clinical trials and genome-wide association studies are typical tools to evaluate effectiveness of certain treatments, drugs, to determine dependencies between DNA patterns and diseases, and so forth. In clinical trials, eligibility criteria for inclusion in a trial can include patients with DNA sequences that have similar phenotype (e.g. race) and functionality (e.g. a gene is on or off). In genome-wide association studies, to conduct tests, DNA sequences are selected that can be divided into cases (e.g. sequences that contain a mutation) and controls (sequences that do not contain a mutation). In genetic anthropology, the goal is commonly to identify DNA samples having strong similarity with a reference DNA sample (or reference DNA sample pool) in order to trace population migrations, to study genetic divergence over time, or so forth. These are merely illustrative examples of applications that utilize DNA sequence comparisons.

The human DNA genome is composed of roughly 3.2×10⁹ nucleotides collectively encoding approximately 30,000 genes. Genomes for animals, plants and other organisms can vary widely, but are typically of comparable order of magnitude. To find eligible patients for a clinical trial, or DNA sequences for research purposes, or so forth, huge databases may need to be processed. Accordingly, rapid procedures for locating similar DNA sequences are advantageous. Such searches are complicated by numerous issues such as the sheer size of the DNA genome and the sometimes fragmentary nature of experimentally acquired DNA sequences which can include gaps, alignment errors, differences in total sequence length, various types of noise, and so forth.

When dealing with human DNA, another consideration is subject privacy. DNA sequences encode the entire hereditary record, and can reveal medically or personally sensitive information such as risk predisposition for certain diseases, ancestry information, and so forth. DNA sequences are also unique identifiers of human beings (with the exception of monozygotic, i.e. identical, twins). Similar considerations can arise in processing non-human genomic sequence data of commercially valuable organisms such as racehorses, crop plants, and so forth. Concern about control of such information is illustrated by the Genetic Information Nondiscrimination Act (GINA) of 2008, which is intended to bar discrimination in the United States by health insurers and employers based on health information derived from individuals' DNA. However, GINA does not cover life insurance, disability insurance and long-term care insurance. DNA sequences also implicate unique considerations compared with other types of personal medical data. The human genome is far from being entirely understood, and so there is an ongoing potential for new technologies to extract new personally sensitive information from DNA. Also, unlike other medical information, DNA sequences cannot be anonymized, as they are identifiers by themselves. Thus, DNA matching should preferably be done in a manner that enforces data security.

The following contemplates improved apparatuses and methods that overcome the aforementioned limitations and others.

According to one illustrative aspect, a non-transitory storage medium stores instructions executable by an electronic data processing device to perform a method including: generating a sequences index comprising sequence models for DNA or RNA sequences stored in a database, the generating including computing the sequence model for each DNA or RNA sequence stored in the database as a finite memory tree source model and parameters for the finite memory tree source model; and identifying one or more DNA or RNA sequences stored in the database as being most similar to a query DNA or RNA sequence based on the results of fitting of the sequence models to the query DNA or RNA sequence.

According to another illustrative aspect, a method comprises: generating a sequences index comprising context tree weighting (CTW) models {Sₓ, Θ_{S}_{ₓ}} for DNA or RNA sequences stored in a database, where Sₓ denotes the context tree model for the DNA or RNA sequence x and Θ_{S}_{ₓ} denotes parameters of the context tree model Sₓ; and identifying one or more DNA or RNA sequences stored in the database as being most similar to a query DNA or RNA sequence y based on fitting of the CTW models {Sₓ, Θ_{S}_{ₓ}} to the query DNA or RNA sequence y. The generating and the identifying are suitably performed by an electronic data processing device.

According to another illustrative aspect, an apparatus comprises an electronic data processing device programmed to perform a method including: retrieving sequence models from a sequences index that model DNA or RNA sequences stored in a database, the retrieved sequence model for each DNA or RNA sequence stored in the database comprising a finite memory tree source model and parameters for the finite memory tree source model; and identifying one or more DNA or RNA sequences stored in the database as being most similar to a query DNA or RNA sequence based on fitting of the retrieved sequence models to the query DNA or RNA sequence.

One advantage resides in providing fast comparison of genomic sequences.

Another advantage resides in providing an indexing method for indexing genomic sequences in a manner providing fast comparison while maintaining anonymity.

Another advantage resides in providing an indexing method for indexing genomic sequences using index records including precomputed finite memory tree source models and model parameters so as to facilitate fast comparison of a query genomic sequence with the index records.

Numerous additional advantages and benefits will become apparent to those of ordinary skill in the art upon reading the following detailed description.

The invention may take form in various components and arrangements of components, and in various process operations and arrangements of process operations. The drawings are only for the purpose of illustrating preferred embodiments and are not to be construed as limiting the invention.

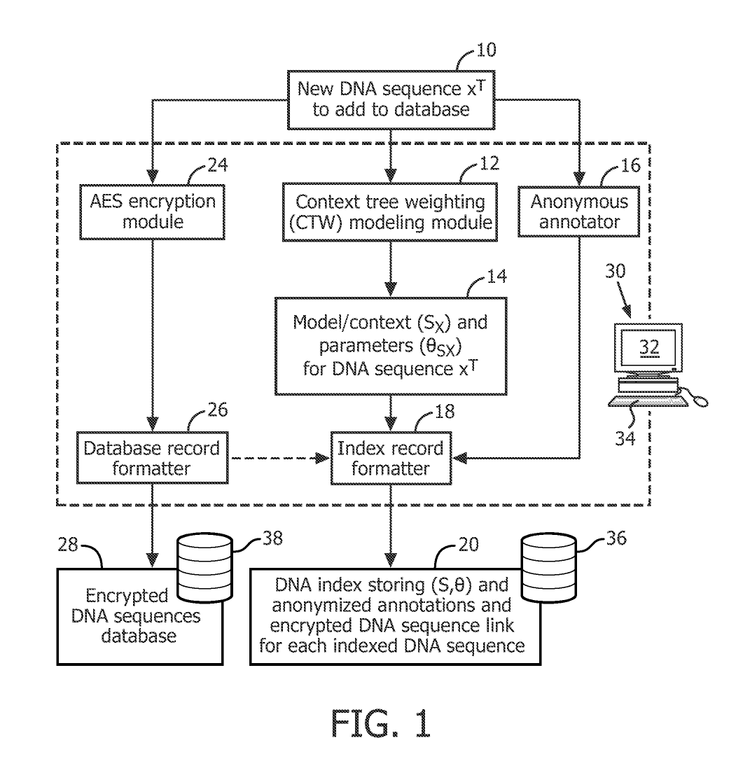

FIG. 1 diagrammatically shows a system for storing and indexing DNA sequences.

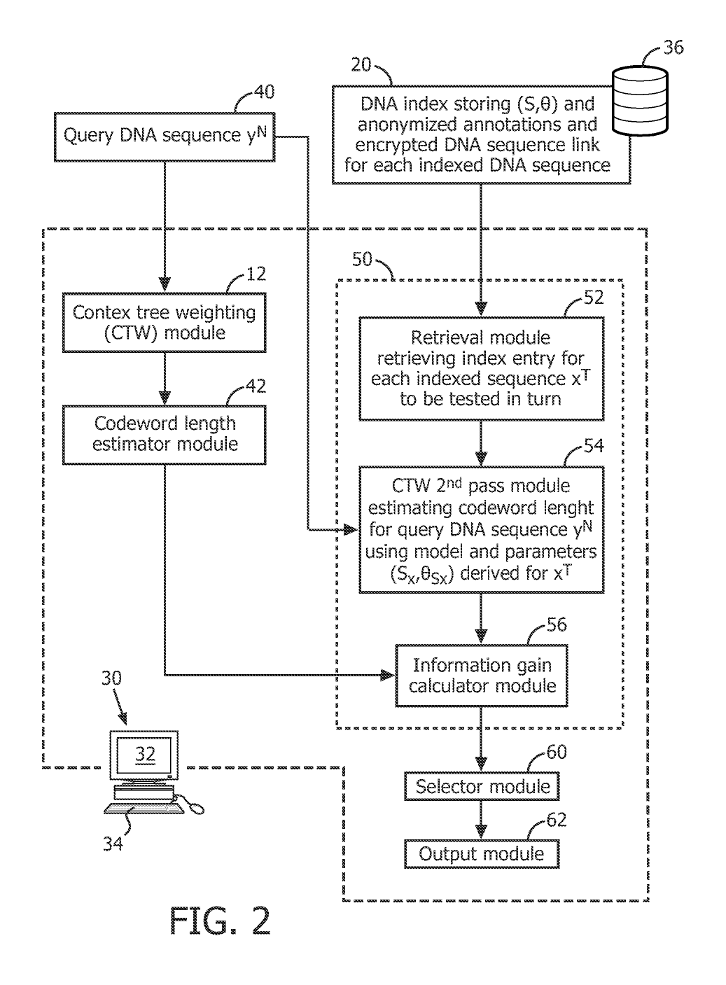

FIG. 2 diagrammatically shows a system for searching the DNA sequences index generated by the system of FIG. 1 to identify DNA sequences similar to a query DNA sequence.

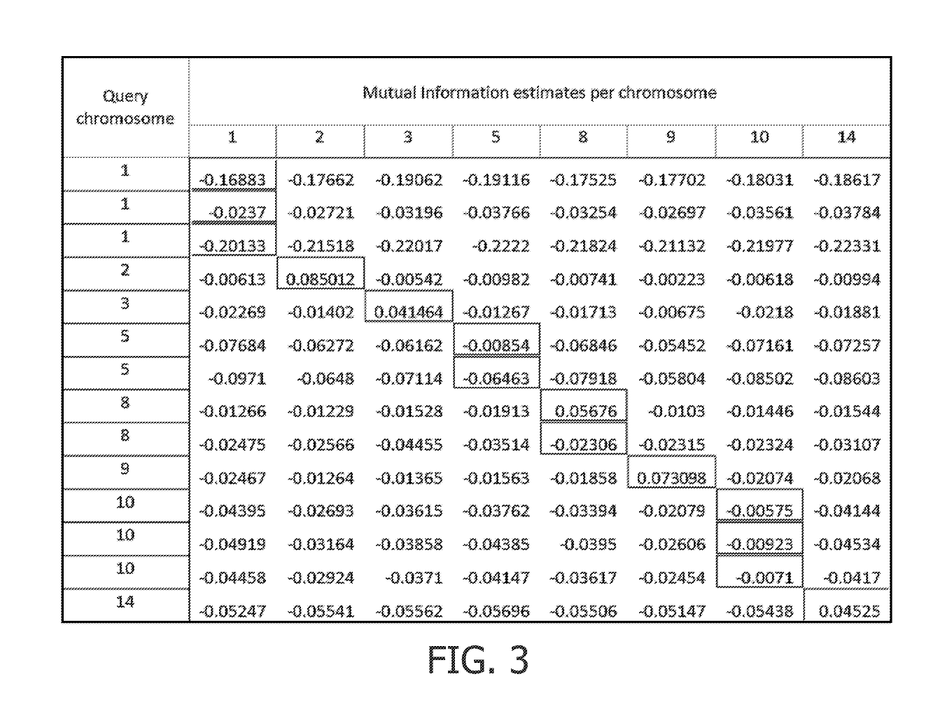

FIG. 3 shows a table of estimates for mutual information from an illustrative actually-performed DNA retrieval operation, with the maximum mutual information for each query chromosome indicated by an enclosing box.

Disclosed herein is an approach for indexing DNA sequences (or, more generally, genomic sequences, e.g. DNA sequences, RNA sequences, or so forth) using a finite memory tree source model such as a (e.g. fixed or variable order) Markov model, context tree weighting (CTW) model (the illustrative approach used herein), or so forth. An index record for the DNA sequence is then constructed, including the model and parameters. Then, the estimated codeword length obtained using the same finite memory tree model for a query DNA sequence, compared with the codeword length estimated by direct modeling of the query DNA sequence using CTW, serves as a comparison metric for quantitatively assessing similarity of the query and indexed DNA sequences. The codeword length comparison is for example computed using a mutual information metric such as entropy or information gain (IG) or similar means.

This approach preserves privacy of patients whose DNA sequences are stored in a database since only the finite memory tree source model and parameters are stored in the clear, i.e. unencrypted. The use of finite length subsequences ensures patient privacy as the resulting model and parameters contain far less information than the original DNA sequence, and the output of the finite memory tree source model is inherently statistical in nature. The search is fast, since the model and its parameters for the indexed (set of) DNA sequences are pre-computed. The disclosed similarity metric is also more flexible and expressive than other metrics such as edit or set distance, since mutual information is used as a retrieval criterion. As disclosed herein, mutual information is suitably estimated based on a universal compression method that is sequential and explores temporal structure of genomic sequences.

With reference to FIG. 1, an illustrative system for storing and indexing DNA sequences is described. A DNA sequence 10 to be indexed (denoted here as x^{T} where the superscript T denotes the DNA sequence length) is processed to generate a representative finite memory tree source model of the DNA sequence 10. In the illustrative example, the finite memory tree source model is a context tree weighting (CTW) model computed using the CTW method. The output 14 of the modeling module 12 applied to DNA sequence x^{T} is the finite memory tree source model and its parameters. In the illustrative CTW modeling, the context tree model (i.e. the context or subsequences) is denoted here as Sₓ (or more simply as S where the identity of the modeled DNA sequence x^{T} is apparent), and the parameters comprise conditional probabilities, denoted herein as Θ_{S}_{ₓ} (or more simply as Θ_{S} where the identity of the modeled DNA sequence x^{T} is apparent). Preferably, descriptive annotations are provided via an anonymous annotator 16. In applications in which patient privacy is important, the annotations should be anonymous, but should constitute a relevant description of the source of the DNA sequence 10, e.g. describing the source by demographic information, clinical information, or so forth. If the application does not require anonymity, then the annotator 16 may include a subject identifier in the annotation. An index record formatter 18 constructs an index record including the model and parameters 14 and the annotations, and the index record is stored in a database 20, such as an electronic health record (EHR), a DNA repository index employed for academic purposes, or so forth.

The index record includes the model and parameters 14, for example represented as (Sₓ, Θ_{S}_{ₓ}) for the DNA sequence x^{T}. This is an expressive but approximate representation of the DNA sequence x^{T}, and is insufficient to identify the subject from which the DNA sequence x^{T} was derived. Accordingly, the DNA sequence x^{T} is stored separately in a suitably secure format. To this end, an encryption module 24, which in the illustrative embodiment of FIG. 1 employs an encryption algorithm complying with the Advanced Encryption Standard (AES encryption), encrypts the DNA sequence 10. The encryption module performs security encryption, and optionally also performs lossless compression either in a separate operation or integrally via a combined compression/encryption algorithm. A database record formatter 26 formats the encrypted (and optionally compressed) DNA sequence and stores it in an encrypted DNA sequence database 28.

With continuing reference to FIG. 1, the indexing system is suitably physically embodied as follows. A computer 30 or other electronic data processing device (e.g. computer, Internet-based server linked by a secure encrypted transmission protocol, or so forth) is suitably programmed to implement the data processing modules 12, 18, 24, 26. The anonymous annotator 16 may be variously implemented, for example as a fully automated system that extracts demographic or other relevant information from an EHR or other database and performs anonymization of that information as appropriate, or as a semi-automated system employing a user interface (e.g. illustrative display 32 and keyboard 34) to enable a human operator to input the relevant information, or so forth. The DNA sequences index database 20 is suitably implemented on a non-transitory storage medium 36 such as a magnetic disk, redundant array of independent disks (RAID), optical disk, or so forth. Likewise, the encrypted DNA sequences database 28 is suitably implemented on a non-transitory storage medium 38 such as a magnetic disk, redundant array of independent disks (RAID), optical disk, or so forth.

In illustrative FIG. 1, the same computer 30 implements both the indexing modules 12, 18 and the annotator 16 or automated portions thereof, and the sequence encryption and storage modules 24, 26, while physically separate data storage media 36, 38 store the respective index 20 and database 28. This approach can be advantageous since it is typical for the DNA sequence to be stored and indexed as a workflow block (so that a single computer 30 is suitably employed) while keeping the index 20 and database 28 on separate media can enhance security. In this approach, the index record for the DNA sequence 10 stores a link to the encrypted DNA sequence record stored in the database 28 (diagrammatically indicated in FIG. 1 by a dotted arrow connecting the database record formatter 26 to the index record formatter 18 indicating conveying the link to the latter for inclusion in the index record.

It will be appreciated that alternative physical implementations are possible. For example, separate computers can be used to implement the indexing operations 12, 16, 18 and the encryption/storage operations 24, 26, respectively. Additionally or alternatively, the encrypted DNA sequence and the corresponding index record can be stored on the same physical non-transitory storage medium. As a further variation, it is contemplated to merge the index 20 and the encrypted DNA sequences database 28 by including the encrypted DNA sequence as an element of the index record. This may be appropriate if the AES or other encryption protocol is deemed sufficiently secure. (In any event, the decryption key should be stored separately, or in some other secure fashion).

In the following, operation of the illustrative CTW modeling module 12 is further described.

The context-tree weighting (CTW) method (Willems et al., The Context Tree Weighting Method: Basic Properties, IEEE transactions on Information theory, 1995) computes a coding distribution that corresponds to all tree-models whose depth does not exceed a specified maximum depth D. The distribution can be used to compress the observed DNA sequence 10 using arithmetic coding techniques that results in a codeword with small redundancy. In practice, the actual compression does not need to be performed;

rather, the techniques disclosed herein estimate the codeword length which is indicative of the amount of compression that would be obtained using the model to compress the DNA sequence. The codeword length divided by the length of the source sequence gives a good estimate of the entropy.

The DNA sequence structure is such that it codes for amino acids and subsequently for proteins in a sequential way. Let x^{T} denote the observed DNA sequence 10. (More generally, x^{T} can denote a set of sequences modeled together by the same context tree model and parameters). Then CTW can be used to estimate P (x^{T}), where x^{T} is suitably represented as a vector with values from alphabet A={1,2,3,4}. (Note that DNA alphabet is typically represented as {A, T, G, C} where A denotes adenine, T denotes thymine, G denotes guanine, and C denotes cytosine; while the RNA alphabet is typically {A, U, G, C} where thymine is replaced by U representing uracil. The alphabet A={1,2,3,4} is used here without loss of generality. It is also contemplated to employ an alphabet with more than four symbols, e.g. to capture information such as methylation.) Denote with xₜ a symbol from alphabet A at position t in the observed sequence x^{T}. A statistical model for the DNA sequence is estimated by building the context tree and estimating the distribution P (x^{T}) using the CTW algorithm as P(xₜ|{x_{t-b}, b∈B}), where B is a set of well-chosen integers. The “context” {x_{t-b}, b∈B} consists of a set of values from alphabet A obtained from |B| different locations of x^{T}. Typically, B is defined as a set of values preceding xₜ (up to the maximum depth D). All possible contexts (that actually occurred in the observed DNA sequence) together with probability distribution P(xₜ|{x_{t-b}, b∈B}) constitute the context-tree (model) and the parameters, respectively.

The output of the CTW algorithm is the context tree model and conditional probabilities {S, Θ_{S}}. For a given DNA sequence, the amount of compression that would be obtained if the DNA sequence were compressed using {S, Θ_{S}} can be characterized by an estimated codeword length L. As disclosed herein, the CTW method can also be used in a two-pass approach: in the first step the statistical model {S, Θ_{S}} is derived for an observed DNA sequence, and in the second step the codeword length is estimated which indicates the amount of compression of the DNA sequence achievable using the model. The estimate is based on fixed conditional probabilities provided by {S, Θ_{S}} obtained in the first pass; by comparison, in conventional (single-pass) CTW the codeword length is computed based on probabilities that are being updated all the time, as each symbol is processed. As further disclosed herein, this two-pass approach can be extended to define a similarity measure for two different DNA sequences, by performing the first step on one DNA sequence (the reference or indexed sequence, which may in general be a set of reference or index sequences modeled together) and then using the resulting model to estimate a codeword length for a second (query) DNA sequence. Since the model was derived from the indexed DNA sequence, it should produce an optimally short codeword length for the indexed DNA sequence. On the other hand, when the model is applied to the query DNA sequence, the codeword length will depend on how similar the query DNA sequence is to the indexed DNA sequence. If they are similar, then the model will “fit” well and would provide a high degree of compression, corresponding to a short estimated codeword length. On the other hand, if they are dissimilar, then the fit will be poor and the estimated codeword length for the query sequence will be longer than would be obtained for the optimal model. The codeword length obtained for a model derived from the query sequence provides a suitable reference length. An illustrative quantitative formulation follows.

Consider an observed DNA sequence x^{T}. Suppose {S, Θ_{S}} are a model (contexts) and parameter set (conditional probabilities) describing some tree source of depth not larger than D. Note that in this example {S, Θ_{S}} is not necessarily derived from x^{T}. Then if the model with parameters {S, Θ_{S}} is used to compress the DNA sequence x^{T}, the length L of the compressed sequence will be given by:

$$L ( {x}^{T} \vert {x}_{- D}^{1} , S , {Θ}_{S} ) = - {\sum }_{t = 1}^{T} {log}_{2} P ( {x}_{t} \vert {x}_{- D}^{t - 1} , S , {Θ}_{S} ) = - {\sum }_{t = 1}^{T} {log}_{2} {θ}_{{σ}_{\{ {x}_{- D}^{t - 1} \}}}^{{x}_{t}} \qquad ( 1 )$$

where in Equation (1) the expression

$${σ}_{\{ {x}_{- D}^{t - 1} \}}$$

is a mapping of x_{-D}^{t-1} to a context from S, and

$$P ( {x}_{t} \vert {x}_{- D}^{t - 1} , S , {Θ}_{S} ) = {{θ}_{σ}^{{x}_{t}}}_{\{ {x}_{- D}^{t - 1} \}} εΘ$$

is the probability of symbol xₜ to occur after subsequence

$${σ}_{\{ {x}_{- D}^{t - 1} \}}$$

was observed in x^{T}. When {S, Θ_{S}} describes the actual source that produced x^{T} (e.g., in the above example, if x^{T} is the indexed DNA sequence) then L(x^{T}|x_{-D}¹, S, Θ_{S}) corresponds to the ideal codeword length which is a minimum codeword length. However, if {S, Θ_{S}} describes some other source (e.g., in the above example if x^{T} is the query sequence) then L(x^{T}|x_{-D}¹, S, Θ_{S}) will (at least in general) be much larger than the ideal codeword length as the model was derived for another DNA sequence and does not as effectively describe the observed DNA sequence x^{T}. Note that when the CTW method is used to estimate the model and parameters of an observed (DNA) sequence, then the resulting codeword length will have the smallest distance (redundancy) from the ideal codeword length.

A similarity measure can be defined using this concept that the codeword length is indicative of how well the model fits the DNA sequence whose codeword length is estimated using the codeword length estimation of Equation (1). Suppose y^{N} and x^{T} are two observed DNA sequences not necessarily of the same length. In analogy to the earlier example, let x^{T} be the indexed DNA sequence of length T, and y^{N} be the query DNA sequence of length N. Let {Sₓ, Θ_{S}_{ₓ}} be the model and parameter set derived for x^{T} using the CTW method. Advantageously, {Sₓ, Θ_{S}_{ₓ}} may be precomputed for the indexed DNA sequence x^{T} 10 and stored in the DNA index 20 as described with reference to FIG. 1. Furthermore, let L_{ctw}(y^{N}) be the codeword length for the (query) DNA sequence y^{N} estimated using the CTW method. Said another way, L_{ctw}(y^{N}) is the codeword length obtained using the model {S_{y}, Θ_{S}_{_{y}}} derived for the query DNA sequence y^{N}. Thus, L_{ctw}(y^{N}) is the optimal (that is, shortest) codeword length obtainable for y^{N} using the CTW method. Then the difference:

$$\frac{1}{N} {L}_{ctw} ( {y}^{N} ) - \frac{1}{N} L ( {y}^{N} \vert {S}_{x} , {Θ}_{{S}_{x}} ) = - \frac{1}{N} {\sum }_{t = 1}^{N} {log}_{2} {P}_{ctw} ( {y}_{t} \vert {y}_{- D}^{t - 1} ) + \frac{1}{N} {\sum }_{t = 1}^{N} {log}_{2} P ( {y}_{t} \vert {y}_{- D}^{t - 1} , {S}_{x} , {Θ}_{{S}_{x}} ) = - \frac{1}{N} {\sum }_{t = 1}^{N} {log}_{2} \frac{{P}_{ctw} ( {y}_{t} \vert {y}_{- D}^{t - 1} )}{P ( {y}_{t} \vert {y}_{- D}^{t - 1} , {S}_{x} , {Θ}_{{S}_{x}} )} = - \frac{1}{N} {\sum }_{t = 1}^{N} {log}_{2} \frac{{P}_{ctw} ( {y}_{t} \vert {y}_{- D}^{t - 1} )}{{θ}_{{S}_{x} , {σ}_{\{ {y}_{- D}^{t - 1} \} \\}}^{{y}_{t}}} \qquad ( 2 )$$

can be computed. It is seen that the difference of Equation (2) indicates how much can be gained if the distribution of x^{T} is used instead of y^{N} in order to describe (compress) y^{N}. If the gain is high then {Sₓ, Θ_{S}_{ₓ}} describes the source that fits well y^{N} and thus we can assume that both y^{N} and x^{T} are generated by the same source and consider them to be similar. If the gain is low, then codeword length for y^{N} estimated using {Sₓ, Θ_{S}_{ₓ}} has very high redundancy and thus {Sₓ, Θ_{S}_{ₓ}} does not help to compress y^{N}, which means that it corresponds to some other source generating other types of (DNA) sequences. Hence we can say that y^{N} and x^{T} are generated by different sources and they are not similar. In general, the higher the gain the better the model and parameter set {Sₓ, Θ_{S}_{ₓ}} describe sequence y^{N}. Thus it is the more likely, that the source with {Sₓ, Θ_{S}_{ₓ}} generated y^{N}.

The codeword length per source symbol estimated using the CTW method gives an estimate of the entropy of the DNA source sequence. Hence the similarity measure of Equation (2) is also an estimate of the mutual information between a DNA sequence y^{N} and a DNA source that produced some DNA sequence x^{T}. The estimation of mutual information provided by Equation (2) is an underestimate. This can be seen because mutual information is strictly non-negative. In contrast, Equation (2) takes the difference (scaled by 1/N) between L_{ctw}(y^{N}) which is the optimal (smallest) codeword length and L(y^{N}|Sₓ, Θ_{S}_{ₓ}) which is a non-optimal (and hence larger) codeword length. It follows that Equation (2) generally can take up negative values, which are generally smaller than the strictly non-negative true mutual information values. The underestimate of the mutual information given by Equation (2) partially comes as a result of the coding redundancy in the second term. The underestimate does not negate the usefulness of Equation (2) as a similarity measure; however, it is to be understood that higher similarity (i.e. larger information gain) is indicated by a “less negative” value output by the similarity measure of Equation (2).

In view of the foregoing, a similarity measure I that measures similarity between a query DNA sequence y^{N} and an indexed DNA sequence x^{T} for which a model and parameter set {Sₓ, Θ_{S}_{ₓ}} is precomputed and stored in the index database 20 is suitably computed using Equation (2), or in other words I(y^{N}; x^{T}, {Sₓ, θ_{S}_{ₓ}}) is suitably estimated using Equation (2).

As an example, consider the problem of finding the indexed DNA sequence x^{T} in the DNA sequences index 20 that is most similar to a query DNA sequence y^{N}. This translates to finding max_{P(x}_{^{T}}₎I(Y^{N}; X^{T}). When {Sₓ, Θ_{S}_{ₓ}} is a function of x^{T} then by the data processing inequality:

$${max}_{P ( {x}^{T} )} I ( {y}^{N} ; {x}^{T} ) = {max}_{P ( {x}^{T} )} I ( {y}^{N} ; {x}^{T} , \{ {S}_{x} , {Θ}_{{S}_{x}} \} ) = {max}_{P ( {x}^{T} )} ( I ( {y}^{N} ; \{ {S}_{x} , {Θ}_{{S}_{x}} \} ) + I ( {y}^{N} ; {x}^{T} \vert \{ {S}_{x ,} {Θ}_{{S}_{x}} \} ) ) \geq {max}_{P ( {x}^{T} )} I ( {y}^{N} ; \{ {S}_{x} , {Θ}_{{S}_{x}} \} ) , \qquad ( 3 )$$

When {Sₓ, Θ_{S}_{ₓ}} matches the source that generated y^{N} the inequality becomes the equality. The most similar indexed DNA sequence is the one that maximizes I(Y^{N}; {Sₓ, Θ_{S}_{ₓ}}).

With reference now to FIG. 2, a system for searching the DNA sequences index 20 generated by the system of FIG. 1 to identify DNA sequences similar to a query DNA sequence y^{N} is described. A query DNA sequence y^{N} 40 is received. The context tree weighting (CTW) module 12 (already described in conjunction with the indexing system of FIG. 1) is applied to derive the model and parameters {S_{y}, Θ_{S}_{_{y}}} for the query DNA sequence y^{N} (this is the first pass of the two-pass version of CTW), and a codeword length estimator module 42 applies Equation (1) to estimate the optimal (smallest) codeword length L_{ctw}(y^{N}) obtained using {S_{y}, Θ_{S}_{_{y}}} (the second pass of the two-pass CTW).

Each indexed DNA sequence x^{T} is then tested in turn by an iteration of a test loop 50, which begins by invoking a retrieval module 52 to retrieve the index entry for the indexed DNA sequence x^{T} currently under test. This index entry provides the model and parameters set {Sₓ, Θ_{S}_{ₓ}} derived for x^{T} using CTW (that is, by the CTW module 12 as described with reference to FIG. 1). In an operation 54, Equation (1) is again applied to estimate the (non-optimal, and generally larger) codeword length L(y^{N}|Sₓ, Θ_{S}_{ₓ}) for query sequence y^{N} modeled using the model and parameters set {Sₓ, Θ_{S}_{ₓ}} derived for x^{T}. In other words, operation 54 performs the second pass of the two-pass CTW algorithm, but using the model and parameters set {Sₓ, Θ_{S}_{ₓ}} derived for x^{T}. The test loop 50 concludes by computing the estimate of the mutual information

$$\frac{1}{N} {L}_{ctw} ( {y}^{N} ) - \frac{1}{N} L ( {y}^{N} \vert {S}_{x} , {Θ}_{{S}_{x}} ) .$$

As an alternative, the operation 54 can be omitted and the last expression of Equation (2) can instead be used to compute

$$\frac{1}{N} {L}_{ctw} ( {y}^{N} ) - \frac{1}{N} L ( {y}^{N} \vert {S}_{x} , {Θ}_{{S}_{x}} )$$

directly.

The test loop 50 is repeated for each indexed DNA sequence x^{T} under test. (This may be every DNA sequence indexed in the DNA index 20, or alternatively may be some sub-set of the index generated by filtering based on anonymized annotation). A selector module 60 then selects the one (or more) indexed DNA sequences that are most similar to the query DNA sequence y^{N}. This may select the single most similar indexed DNA sequence, e.g. as per Equation (3), or a “top-K” most similar indexed DNA sequences may be selected (that is, the K indexed DNA sequences having the highest mutual information), a “top-K” most similar indexed DNA sequences ranked by similarity as measured by the mutual information metric, or a threshold may be employed, e.g. all indexed DNA sequences whose mutual information exceeds a threshold are selected, or so forth. An output module 62 then displays or otherwise presents in human-perceptible form the one or more most similar indexed DNA sequences selected by the selector module 60.

In the illustrative example of FIG. 2, the processing components 12, 42, 50, 60, 62 are embodied by the same computer 30 or other electronic data processing device that embodies the indexing modules 12, 18, 24, 26, via suitable software implementing the functionality of processing components 12, 42, 50, 60, 62. Alternatively, different computers may be employed for the indexing and retrieval operations performed by the systems of respective FIGS. 1 and 2. The output module 62 may display information about the selected indexed DNA sequences on the display 32, or may transmit this information to another computer (e.g. a repository computer controlling access to the encrypted DNA sequences database 28), or may generate a printed report (in conjunction with a printer or other marking engine), or so forth. It is to be appreciated that the output module 62 typically does not actually decrypt and provide the actual indexed DNA sequences, since this would compromise data security and subject privacy. Rather, the output module identifies the sequences of interest (based on similarity to the query DNA sequence y^{N}), and the actual sequences are decrypted and provided to authorized personnel after a suitable security clearance process is performed.

It is also to be appreciated that the DNA sequence indexing modules 12, 18, 24, 26 and/or the DNA sequence retrieval modules 12, 42, 50, 60, 62 may be embodied as a non-transitory storage medium encoding instructions (i.e. software) executable by a computer 30 to perform the functions of the indexing modules 12, 18, 24, 26 and/or retrieval modules 12, 42, 50, 60, 62. The non-transitory storage medium may, for example, comprise one or more of a hard disk drive or other magnetic storage medium, a random access memory (RAM), read-only memory (ROM), flash memory or other electronic storage medium, an optical disk or other optical storage medium, various combinations thereof, or so forth.

By way of brief review, the illustrative indexing system embodiment of FIG. 1 performs indexing including create the DNA database 28 of (sets of) DNA sequence(s) xᵢ^{T}^{ᵢ}, i=1,2, . . . , n and the corresponding anonymized DNA sequences index 20. In order to do this, the models and parameters {Sₓ_{ᵢ}, Θ_{S}_{ₓᵢ}} are estimated for each (sets of) DNA sequences xᵢ^{T}^{ᵢ}, i=1,2, . . . , n by applying the CTW method, and the

$$\{ {S}_{{x}_{i}} , {Θ}_{{S}_{{x}_{i}}} \}$$

sets are stored in the index database 20 together with some other relevant information (i.e., annotations, optionally anonymized).

The retrieval process of FIG. 2 is given the query (example) DNA sequence y^{N} 40. The CTW algorithm is applied and the codeword length per source symbol

$$\frac{1}{N} {L}_{ctw} ( {y}^{N} )$$

is estimated for y^{N} using modules 12, 42. For each DNA index record i, i=1,2, . . . , n in the index database 20, the codeword length is estimated for y^{N} given {Sₓ_{ᵢ}, Θ_{S}_{ₓᵢ}} by mapping subsequences in y^{N} to the contexts from Sₓ_{ᵢ} and using the corresponding parameters to calculate

$$\frac{1}{N} L ( {y}^{N} \vert {S}_{{x}_{i}} , {Θ}_{{S}_{{x}_{i}}} ) = - {\sum }_{t = 1}^{N} {log}_{2} {θ}_{{S}_{{x}_{i}} , {σ}_{\{ {y}_{- D}^{t - 1} \}}}^{{y}_{t}}$$

(CTW 2^{nd} pass module 54). (Note that if there is no context in Sₓ_{ᵢ} for some subsequence from y^{N}, then the corresponding parameter is suitably set to some suitable value such as ½.) The record î is selected (module 60) indexing the DNA sequence that maximizes the information gain estimate

$$\frac{1}{N} {L}_{ctw} ( {y}^{N} ) - \frac{1}{N} L ( {y}^{N} \vert {S}_{{x}_{i}} , {Θ}_{{S}_{{x}_{i}}} ) ,$$

and the relevant information is returned (module 62) to the querying party.

It will be appreciated that in the index database 20 one need only to store the model and the parameter set

$$\{ {S}_{{x}_{i}} , {Θ}_{{S}_{{x}_{i}}} \}$$

corresponding to a (set of) DNA sequence(s). This information alone cannot be used to reconstruct the DNA sequence(s), since it only provides probabilistic characterization of a source that produced the actual sequence(s).

With reference to FIG. 3, an illustrative example of the disclosed retrieval process is set forth. This example uses 14 DNA sequences from GenBank. The goal is to arrange the database per chromosome. In this example the CTW method uses depth D=9 (corresponds to three codons) to estimate the models and parameter sets for each chromosome, i.e. for chromosome 1, 2, 3, 5, 8, 9, 10, 14 in this example. These models and parameter sets are stored in the index database. The query DNA sequence is a human DNA sequence fragment, and the goal is to determine which chromosome it comes from. Using the retrieval system of FIG. 2 with the indexed DNA sequences corresponding to chromosome 1, 2, 3, 5, 8, 9, 10, 14, the estimates of the mutual information between the query DNA sequence fragment and the models and parameters corresponding to different (indexed) chromosomes are calculated, and the chromosome that maximizes the mutual information is returned. FIG. 3 presents the results of such estimates for a number of query sequences. It is observed in FIG. 3 that the proposed method correctly detected from which chromosome the query piece of DNA comes. It should be noted that the query DNA fragments were not complete chromosomes; rather, DNA sequence length N of the query fragment y^{N} was a small fraction of the length T of the indexed (full chromosome) DNA sequences x^{T}.

The illustrative embodiments are intended as examples, and numerous variants are contemplated. For example, while CTW is employed in the illustrative embodiments, other finite memory tree source models can be employed, such as various finite length Markov chain models or variable order Markov models. In general, the approach generates a sequences index 20 comprising sequence models for DNA (or RNA) sequences stored in the (preferably encrypted) database 28. The sequence model for each DNA (or RNA) sequence stored in the database 28 comprises a finite memory tree source model and parameters for the finite memory tree source model. In the illustrative examples, the sequence model for each indexed DNA sequence x^{T} is the model and parameters set {Sₓ_{ᵢ}, Θ_{S}_{ₓᵢ}} derived from x^{T} using CTW.

In the retrieval phase, one or more DNA (or RNA) sequences stored in the database 28 are identified as being most similar to a query DNA (or RNA) sequence 40 based on fitting of the sequence models to the query DNA (or RNA) sequence. In the illustrative embodiments, codeword length is used to assess the fitting of the sequence models to the query DNA sequence. More generally, any compression metric that measures the amount of compression of the query DNA sequence achievable using the finite memory tree source model can be used to assess the model fit. The sequence model fits the query DNA (or RNA) sequence better if the compression metric indicates a higher level of compression is achievable by applying the model to the query DNA (or RNA) sequence.

The illustrative similarity (or comparison) metrics are formulated as (approximate) information gain (or, equivalently, mutual information or change in entropy) expressions. Equation (2) is an example. However, these can be simplified in some cases. For example, normalization by N may be omitted in Equation (2) if there is only one query DNA sequence (so that N is the same in all cases). In fact, if only one query DNA sequence is being employed in the retrieval, the similarity metric can be reduced to the estimated codeword (i.e. compression metric) given by

$$L ( {y}^{N} \vert {S}_{{x}_{i}} , {Θ}_{{S}_{{x}_{i}}} )$$

alone, since the L_{ctw}(y^{N}) term is a constant offset in this case. To obtain an approximate information gain formulation, the similarity or comparison metric suitably compares the value of a compression metric (such as the CTW codeword length estimate) obtained for compressing the query DNA (or RNA) sequence using a finite memory tree source model derived from the query DNA (or RNA) sequence (this is

$$\frac{1}{N} {L}_{ctw} ( {y}^{N} )$$

in the illustrative examples) with the values of the compression metric obtained for the query DNA (or RNA) sequence using the sequence models derived from the DNA (or RNA) sequences of the database (these are the

$$\frac{1}{N} L ( {y}^{N} \vert {S}_{{x}_{i}} , {Θ}_{{S}_{{x}_{i}}} )$$

terms in the illustrative examples).

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A non-transitory storage medium storing instructions executable by an electronic data processing device to perform a method including:
generating a sequences index comprising sequence models for deoxyribonucleic acid (DNA) or ribonucleic acid (RNA) sequences stored in a database, the generating including computing the sequence model for each DNA or RNA sequence stored in the database as a finite memory tree source model and parameters for the finite memory tree source model; wherein the sequence models are computed using context tree weighting (CTW); and
identifying one or more DNA or RNA sequences stored in the database as being most similar to a query DNA or RNA sequence based on applying the sequence models to the query DNA or RNA sequence and on determining how well each sequence model fits the query DNA or RNA sequence.

2. (canceled)

3. The non-transitory storage medium of claim 1 wherein the identifying includes:
computing a query model for the query DNA or RNA sequence as a finite memory tree source model and parameters for the finite memory tree source model; wherein the query model is computed using context tree weighting (CTW); and
computing a reference value of a compression metric that measures the amount of compression of the query DNA or RNA sequence achievable using the query model;
wherein the applying of the sequence models to the query DNA or RNA sequence includes estimating an information gain for each sequence model based on a difference between the reference value of the compression metric and a value of the compression metric that measures compressibility of the query DNA or RNA sequence using the sequence model.

4. The non-transitory storage medium of claim 1 wherein the identifying uses the sequence models and does not use the DNA or RNA sequences stored in the database.

5. (canceled)

6. The non-transitory storage medium of claim 25.1 wherein the applying of the sequence models to the query DNA or RNA sequence includes:
for each sequence model, computing the codeword length for the query DNA or RNA sequence using the sequence model.

7. The non-transitory storage medium of claim 1 wherein the identifying includes:
computing a query model for the query DNA or RNA sequence as a finite memory tree source model and parameters for the finite memory tree source model using CTW; and
computing a reference codeword length for the query DNA or RNA sequence using the query model;
wherein the applying of the sequence models to the query DNA or RNA sequence includes estimating an information gain for each sequence model based on a difference between the reference codeword length and the codeword length computed for the query DNA or RNA sequence using the sequence model.

8. The non-transitory storage medium of claim 1 wherein:
the DNA or RNA sequences stored in the database are DNA chromosome sequences, and
the query DNA or RNA sequence is a query DNA sequence fragment smaller than a chromosome.

9. A method comprising:
generating a sequences index comprising context tree weighting (CTW) models {Sₓ, Θ_{S}_{ₓ}} for deoxyribonucleic acid (DNA) or ribonucleic acid (RNA) sequences stored in a database, where denotes the context tree model for the DNA or RNA sequence x and Θ_{S}_{ₓ} denotes parameters of the context tree model Sₓ; and
identifying one or more DNA or RNA sequences stored in the database as being most similar to a query DNA or RNA sequence y based on applying the CTW models {Sₓ, Θ_{S}_{ₓ}} to the query DNA or RNA sequence y and on determining how well each CTW model fits the query DNA or RNA sequence y;
wherein the generating and the identifying are performed by an electronic data processing device.

10. (canceled)

11. The method of claim 9 wherein the identifying uses the CTW models {Sₓ, Θ_{S}_{ₓ}} and does not use the DNA or RNA sequences x stored in the database.

12. The method of claims 9 wherein the identifying further includes:
computing a CTW model {S_{y}, Θ_{S}_{_{y}}} for the query DNA or RNA sequence y where S_{y} denotes the context tree model for the query DNA or RNA sequence y and Θ_{S}_{_{y}} denotes parameters of the context tree model S_{y}; and
computing a reference value of a compression metric that measures compressibility of the query DNA or RNA sequence y using the CTW model {S_{y}, Θ_{S}_{_{y}}} for the query DNA or RNA sequence y;
wherein the applying of the CTW models {Sₓ, Θ_{S}_{ₓ}} to the query DNA or RNA sequence y includes estimating an information gain for each CTW model {Sₓ, Θ_{S}_{ₓ}} based on a difference between the reference value of the compression metric and a value of the compression metric that measures compressibility of the query DNA or RNA sequence y using the CTW model {Sₓ, Θ_{S}_{ₓ}}.

13. The method of claim 9 wherein the identifying further includes:
computing a CTW model {S_{y}, Θ_{S}_{_{y}}} for the query DNA or RNA sequence y where S_{y} denotes the context tree model for the query DNA or RNA sequence y and Θ_{S}_{_{y}} denotes parameters of the context tree model S_{y}; and
computing a reference codeword length for the query DNA or RNA sequence y using the CTW model {S_{y}, Θ_{S}_{_{y}}} for the query DNA or RNA sequence y;
wherein the applying of the CTW models {Sₓ, Θ_{S}_{ₓ}} to the query DNA or RNA sequence y includes estimating an information gain for each CTW model {Sₓ, Θ_{S}_{ₓ}} based on a difference between the reference codeword length and a codeword length computed for the query DNA or RNA sequence y using the CTW model {Sₓ, Θ_{S}_{ₓ}}.

14. The method of claim 9 wherein the fitting of the CTW models {Sₓ, Θ_{S}_{ₓ}} to the query DNA or RNA sequence y includes:
for each CTW model {Sₓ, Θ_{S}_{ₓ}}, computing the codeword length for the query DNA or RNA sequence y using the CTW model {SₓΘ_{S}_{ₓ}}, wherein the identifying preferably includes:
identifying one or more DNA or RNA sequences stored in the database having the shortest codeword lengths for the query DNA or RNA sequence y using the CTW model {Sₓ, Θ_{S}_{ₓ}} as being most similar to the query DNA or RNA sequence y.

15. (canceled)

16. An apparatus comprising:
an electronic data processing device programmed to perform a method including:
retrieving context tree weighting (CTW) models {Sₓ, Θ_{S}_{ₓ}} from a sequences index that model deoxyribonucleic acid (DNA) or ribonucleic acid (RNA) sequences stored in a database, where S_{X} denotes the context tree model for the DNA or RNA sequence x and 0₅ₓ denotes parameters of the context tree model S_{X}; and
identifying one or more DNA or RNA sequences stored in the database as being most similar to a query DNA or RNA sequence y based on applying the retrieved CTW models {Sₓ, Θ_{S}_{ₓ}} to the query DNA or RNA sequence and on determining how well each CTW model fits the query DNA or RNA sequence y.

17. The apparatus of claim 16 wherein the identifying does not use the DNA or RNA sequences stored in the database.

18. (canceled)

19. The apparatus of claim 16 wherein the applying of the retrieved CTW models {Sₓ, Θ_{S}_{ₓ}} to the query DNA or RNA sequence y includes:
for each CTW model {Sₓ, Θ_{S}_{ₓ}}, computing the codeword length for the query DNA or RNA sequence y using the CTW model {Sₓ, Θ_{S}_{ₓ}}.

20. The apparatus of claim 19 wherein the identifying includes identifying one or more DNA or RNA sequences stored in the database as being most similar to the query DNA or RNA sequence y based on having the shortest codeword lengths computed for the query DNA or RNA sequence y using the CTW models {Sₓ, Θ_{S}_{ₓ}} modeling the identified one or more DNA or RNA sequences.
